(19) United States
(12) Patent Application Publication
(10) Pub. No.: US 2026/0148286 A1
(43) Pub. Date: May 28, 2026

(54) METHOD FOR UTILIZING A VISUAL FITTING ROOM WITH ARTIFICIAL INTELLIGENCE AGENT

(71) Applicant: iFashions Inc, Lafayette, CA (US)

(72) Inventor: Ying Zheng, Lafayette, CA (US)

(73) Assignee: iFashions Inc, Lafayette, CA (US)

(21) Appl. No.: 18/959,466

(22) Filed: Nov. 25, 2024

(51) Int. Cl. G06Q 30/0601; G06Q 30/0282

(52) U.S. Cl. CPC G06Q 30/0643; G06Q 30/0282; G06Q 30/0631

(57) ABSTRACT

Embodiments of the present disclosure may include a method for utilizing a visual fitting room through an artificial intelligence (AI)agent.

### BACKGROUND OF THE INVENTION

Embodiments of the present disclosure may include a method for utilizing a visual fitting room through an artificial intelligence (AI)agent.

### BRIEF SUMMARY

Embodiments of the present disclosure may include a method for utilizing a visual fitting room through an artificial intelligence (AI)agent, including Detecting, by one or more processors, an encounter request from a user. In some embodiments, an artificial intelligence engine may be coupled to the one or more processors. In some embodiments, the artificial intelligence engine may be trained by human experts in the field.

In some embodiments, the AI agent may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the AI companion agent. In some embodiments, the AI agent may be configured to be displayed with an appearance of a real human or a humanoid or a cartoon character or an animal character based on the user's choice.

In some embodiments, the real human can be a movie star. In some embodiments, a set of pictures depicting the user's choice can be uploaded to the artificial intelligence engine. In some embodiments, the appearance of the AI agent could be determined by analysis of the set of pictures by the artificial intelligence engine.

In some embodiments, the AI agent may be configured to mimic different personalities. In some embodiments, the AI companion agent's gender, age and ethnicity may be determined by the artificial Intelligence's analysis on input from the user. Embodiments may also include recommending clothing articles by the AI agent. In some embodiments, the artificial intelligence engine may be configured to enable the AI agent to suggest a set of clothing articles based on the user's previous selections and clothing history.

Embodiments may also include allowing the user to take pictures with the suggested set of clothing articles, and providing the option to visualize models or celebrities wearing the same clothing articles. Embodiments may also include enabling the user to rate the models with the clothing articles, with the AI agent subsequently providing tailored suggestions.

In some embodiments, the user can then select the desired clothing articles to purchase based on the AI agent's recommendations. Embodiments may also include generating artistic and contextual images. In some embodiments, the AI agent may be configured to enable the user to take pictures with the clothing articles. In some embodiments, the pictures can be real-time pictures of the user with the clothing articles and some accessories taken by AI agent.

In some embodiments, the pictures also can be pictures of the user uploaded by the user with a combination of real clothing articles, real accessories, visual clothing articles and accessories generated by the AI agent. In some embodiments, the user also can change any part of the combination. In some embodiments, the pictures also can be pictures of any models uploaded by the user with a combination of real clothing articles, real accessories, visual clothing articles and accessories generated by the AI agent.

In some embodiments, the real and visual clothing articles can be any of coats, shirts, pants, skirts and others. In some embodiments, the real and visual accessories can be hats, watches, belts, sunglasses and others. In some embodiments, the AI agent may be configured to create artistic representations or contextual images with work or other backgrounds.

In some embodiments, the AI agent may be configured to add makeup to the user in the generated images or videos, applicable to various types of clothing articles including wedding and work dresses. Embodiments may also include generating movies featuring the user performing actions by the AI agent. In some embodiments, the user may be wearing and changing the clothing articles based on the user's choice. In some embodiments, the AI agent may be configured to modify the dress, makeup, and accessories in the movie based on the user's input.

In some embodiments, the artificial intelligence engine may be configured for real-time speech recognition, speech to text generation, real-time dialog generation, text to speech generation, voice-driven animation, and human avatar generation. In some embodiments, the AI companion agent may be configured to be displayed in full body or half body portrait mode or a face on top of a moving robot. Embodiments may also include claim 4 A system for utilizing a visual fitting room through an artificial intelligence (AI)agent, including one or more processors configured to detect an encounter request from a user.

Embodiments may also include an artificial intelligence engine coupled to the one or more processors, trained by human experts in the field and configured to display the AI agent in various devices such as LED/OLED displays, Android/iOS tablets, Laptops/PCs, or VR/AR goggles. Embodiments may also include overlay graphics on the AI companion agent using a set of multi-layer info panels.

Embodiments may also include display the AI agent with an appearance of a real human, humanoid, cartoon character, or animal character based on the user's choice, with the capability to depict movie stars. Embodiments may also include analyze a set of pictures uploaded by the user to determine the appearance of the AI agent. Embodiments may also include mimic different personalities, and determine the AI companion agent's gender, age, and ethnicity based on user input.

Embodiments may also include a recommendation module configured to enable the AI agent to suggest a set of clothing articles based on the user's previous selections and clothing history. Embodiments may also include an interaction module configured to allow the user to take pictures with the suggested set of clothing articles, and visualize models or celebrities wearing the same clothing articles.

Embodiments may also include a scoring and suggestion module configured to enable the user to rate the models with the clothing articles. Embodiments may also include provide tailored suggestions based on the user's ratings. Embodiments may also include allow the user to select the desired clothing articles to purchase based on the AI agent's recommendations.

Embodiments may also include an image generation module configured to enable the user to take pictures with the clothing articles. In some embodiments, the pictures can be real-time pictures of the user with the clothing articles and some accessories taken by AI agent. In some embodiments, the pictures also can be pictures of the user uploaded by the user with a combination of real clothing articles, real accessories, visual clothing articles and accessories generated by the AI agent.

In some embodiments, the user also can change any part of the combination. In some embodiments, the pictures also can be pictures of any models uploaded by the user with a combination of real clothing articles, real accessories, visual clothing articles and accessories generated by the AI agent. In some embodiments, the real and visual clothing articles can be any of coats, shirts, pants, skirts and others.

In some embodiments, the real and visual accessories can be hats, watches, belts, sunglasses and others. Embodiments may also include create artistic representations or contextual images with work or other backgrounds. Embodiments may also include add makeup to the user in the generated images or videos, applicable to various types of clothing articles including wedding and work dresses. Embodiments may also include a motion picture generation module configured to generate movies featuring the user performing actions while wearing and changing the clothing articles based on the user's choice. Embodiments may also include modify the dress, makeup, and accessories in the movie based on the user's input.

Embodiments of the present disclosure may also include, the method for utilizing a visual fitting room through an artificial intelligence (AI)agent of claim 4. In some embodiments, the artificial intelligence engine may be configured for real-time speech recognition, speech to text generation, real-time dialog generation, text to speech generation, voice-driven animation, and human avatar generation.

Embodiments of the present disclosure may also include, the method for utilizing a visual fitting room through an artificial intelligence (AI)agent of claim 4. In some embodiments, the AI companion agent may be configured to be displayed in full body or half body portrait mode or a face on top of a moving robot.

Embodiments of the present disclosure may also include a method for utilizing a visual fitting room through an artificial intelligence (AI)agent, including Detecting, by one or more processors, an encounter request from a user. In some embodiments, an artificial intelligence engine may be coupled to the one or more processors. In some embodiments, the artificial intelligence engine may be trained by human experts in the field.

In some embodiments, the AI agent may be configured to be displayed in LED/OLED displays, Android/iOS tablets, Laptops/PCs, or VR/AR goggles. Embodiments may also include recommending clothing articles by the AI agent. In some embodiments, the artificial intelligence engine may be configured to enable the AI agent to suggest a set of clothing articles based on the user's previous selections and clothing history.

Embodiments may also include allowing the user to take pictures with the suggested set of clothing articles, and providing the option to visualize models or celebrities wearing the same clothing articles. Embodiments may also include enabling the user to rate the models with the clothing articles, with the AI agent subsequently providing tailored suggestions.

In some embodiments, the user can then select the desired clothing articles to purchase based on the AI agent's recommendations. Embodiments may also include generating artistic and contextual images. In some embodiments, the AI agent may be configured to enable the user to take pictures with the clothing articles. In some embodiments, the pictures can be real-time pictures of the user with the clothing articles and some accessories taken by AI agent.

In some embodiments, the pictures also can be pictures of the user uploaded by the user with a combination of real clothing articles, real accessories, visual clothing articles and accessories generated by the AI agent. In some embodiments, the user also can change any part of the combination. In some embodiments, the pictures also can be pictures of any models uploaded by the user with a combination of real clothing articles, real accessories, visual clothing articles and accessories generated by the AI agent.

In some embodiments, the real and visual clothing articles can be any of coats, shirts, pants, skirts and others. In some embodiments, the real and visual accessories can be hats, watches, belts, sunglasses and others. In some embodiments, the AI agent may be configured to create artistic representations or contextual images with work or other backgrounds.

In some embodiments, the AI agent may be configured to add makeup to the user in the generated images or videos, applicable to various types of clothing articles including wedding and work dresses. Embodiments may also include generating movies featuring the user performing actions by the AI agent. In some embodiments, the user may be wearing and changing the clothing articles based on the user's choice. In some embodiments, the AI agent may be configured to modify the dress, makeup, and accessories in the movie based on the user's input.

In some embodiments, the artificial intelligence engine may be configured for real-time speech recognition, speech to text generation, real-time dialog generation, text to speech generation, voice-driven animation, and human avatar generation. In some embodiments, the AI companion agent may be configured to be displayed in full body or half body portrait mode or a face on top of a moving robot.

### BRIEF DESCRIPTION OF THE FIGURES

FIG. 1 is a flowchart illustrating a method for utilizing a visual fitting room, according to some embodiments of the present disclosure.

FIG. 2 is a block diagram illustrating a system, according to some embodiments of the present disclosure.

FIG. 3 is a flowchart illustrating a method for utilizing a visual fitting room, according to some embodiments of the present disclosure.

FIG. 4 is a diagram showing an example of a method for utilizing a visual fitting room, according to some embodiments of the present disclosure.

FIG. 5 is a diagram showing a second example of a method for utilizing a visual fitting room, according to some embodiments of the present disclosure.

FIG. 6 is a diagram showing a third example of a method for utilizing a visual fitting room, according to some embodiments of the present disclosure.

FIG. 7 is a diagram showing a fourth example of a method for utilizing a visual fitting room, according to some embodiments of the present disclosure.

FIG. 8 is a diagram showing a fifth example of a method for utilizing a visual fitting room, according to some embodiments of the present disclosure.

FIG. 9 is a diagram showing a sixth example of a method for utilizing a visual fitting room, according to some embodiments of the present disclosure.

FIG. 10 is a diagram showing a seventh example of a method for utilizing a visual fitting room, according to some embodiments of the present disclosure.

### DETAILED DESCRIPTION

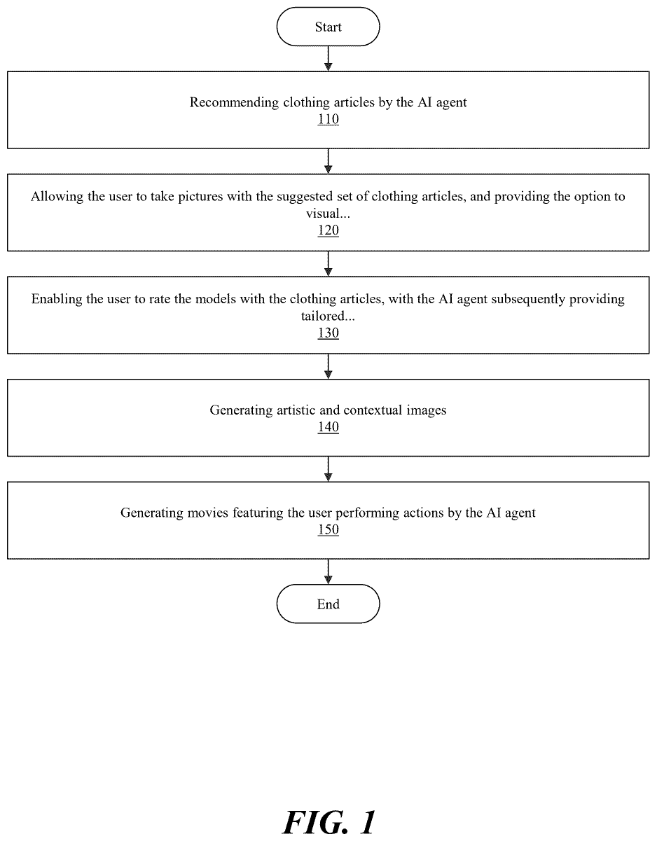

FIG. 1 is a flowchart that describes a method for utilizing a visual fitting room, according to some embodiments of the present disclosure. In some embodiments, at 110, the method may include recommending clothing articles by the AI agent. At 120, the method may include allowing the user to take pictures with the suggested set of clothing articles, and providing the option to visualize models or celebrities wearing the same clothing articles. At 130, the method may include enabling the user to rate the models with the clothing articles, with the AI agent subsequently providing tailored suggestions. At 140, the method may include generating artistic and contextual images. At 150, the method may include generating movies featuring the user performing actions by the AI agent.

In some embodiments, Detecting, by one or more processors, an encounter request from a user. An artificial intelligence engine may be coupled to the one or more processors. The artificial intelligence engine may be trained by human experts in the field. The AI agent may be configured to be displayed in LED/OLED displays, Android/iOS tablets, Laptops/PCs, or VR/AR goggles. A set of multi-layer info panels coupled to the one or more processors may be configured to overlay graphics on top of the AI companion agent.

In some embodiments, the AI agent may be configured to be displayed with an appearance of a real human or a humanoid or a cartoon character or an animal character based on the user's choice. The real human can be a movie star. A set of pictures depicting the user's choice can be uploaded to the artificial intelligence engine. The appearance of the AI agent could be determined by analysis of the set of pictures by the artificial intelligence engine.

In some embodiments, the AI agent may be configured to mimic different personalities. The AI companion agent's gender, age and ethnicity may be determined by the artificial Intelligence's analysis on input from the user. The artificial intelligence engine may be configured to enable the AI agent to suggest a set of clothing articles based on the user's previous selections and clothing history. The user can then select the desired clothing articles to purchase based on the AI agent's recommendations.

In some embodiments, the AI agent may be configured to enable the user to take pictures with the clothing articles. The pictures can be real-time pictures of the user with the clothing articles and some accessories taken by AI agent. The pictures also can be pictures of the user uploaded by the user with a combination of real clothing articles, real accessories, visual clothing articles and accessories generated by the AI agent.

In some embodiments, the user also can change any part of the combination. The pictures also can be pictures of any models uploaded by the user with a combination of real clothing articles, real accessories, visual clothing articles and accessories generated by the AI agent. The real and visual clothing articles can be any of coats, shirts, pants, skirts and others. The real and visual accessories can be hats, watches, belts, sunglasses and others.

In some embodiments, the AI agent may be configured to create artistic representations or contextual images with work or other backgrounds. The AI agent may be configured to add makeup to the user in the generated images or videos, applicable to various types of clothing articles including wedding and work dresses. The user may be wearing and changing the clothing articles based on the user's choice. The AI agent may be configured to modify the dress, makeup, and accessories in the movie based on the user's input. In some embodiments, the artificial intelligence engine may be configured for real-time speech recognition, speech to text generation, real-time dialog generation, text to speech generation, voice-driven animation, and human avatar generation.

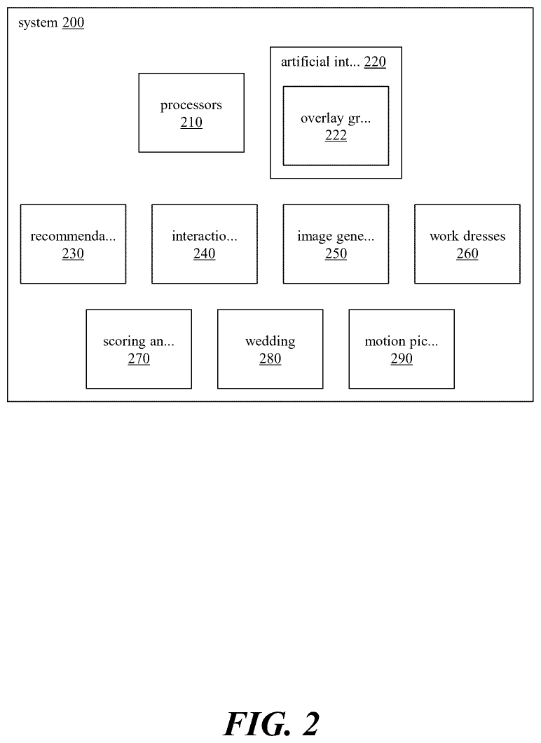

FIG. 2 is a block diagram that describes a system 200, according to some embodiments of the present disclosure. In some embodiments, the system 200 may include one or more processors 210 configured to detect an encounter request from a user, a recommendation module 230 configured to enable the AI agent to suggest a set of clothing articles based on the user's previous selections and clothing history, a scoring and suggestion module 270 configured to:, an image generation module 250 configured to:, wedding 280, work dresses 260, and a motion picture generation module 290 configured to:. The system 200 may also include an artificial intelligence engine 220 coupled to the one or more processors 210, trained by human experts in the field and configured to:. The system 200 may also include an interaction module 240 configured to allow the user to take pictures with the suggested set of clothing articles, and visualize models or celebrities wearing the same clothing articles.

In some embodiments, the artificial intelligence engine 220 may include overlay graphics 222 on the AI companion agent using a set of multi-layer info panels. Display the AI agent in various devices such as LED/OLED displays, Android/iOS tablets, Laptops/PCs, or VR/AR goggles. Display the AI agent with an appearance of a real human, humanoid, cartoon character, or animal character based on the user's choice, with the capability to depict movie stars.

In some embodiments, analyze a set of pictures uploaded by the user to determine the appearance of the AI agent. Mimic different personalities, and determine the AI companion agent's gender, age, and ethnicity based on user input. Enable the user to rate the models with the clothing articles. Provide tailored suggestions based on the user's ratings. Allow the user to select the desired clothing articles to purchase based on the AI agent's recommendations.

In some embodiments, enable the user to take pictures with the clothing articles. The pictures can be real-time pictures of the user with the clothing articles and some accessories taken by AI agent. The pictures also can be pictures of the user uploaded by the user with a combination of real clothing articles, real accessories, visual clothing articles and accessories generated by the AI agent. The user also can change any part of the combination.

In some embodiments, the pictures also can be pictures of any models uploaded by the user with a combination of real clothing articles, real accessories, visual clothing articles and accessories generated by the AI agent. The real and visual clothing articles can be any of coats, shirts, pants, skirts, and others. The real and visual accessories can be hats, watches, belts, sunglasses, and others. Create artistic representations or contextual images with work or other backgrounds. Add makeup to the user in the generated images or videos, applicable to various types of clothing articles. Generate movies featuring the user performing actions while wearing and changing the clothing articles based on the user's choice. Modify the dress, makeup, and accessories in the movie based on the user's input.

In some embodiments, the artificial intelligence engine 220 may be configured for real-time speech recognition, speech to text generation, real-time dialog generation, text to speech generation, voice-driven animation, and human avatar generation. In some embodiments, the AI companion agent may be configured to be displayed in full body or half body portrait mode or a face on top of a moving robot.

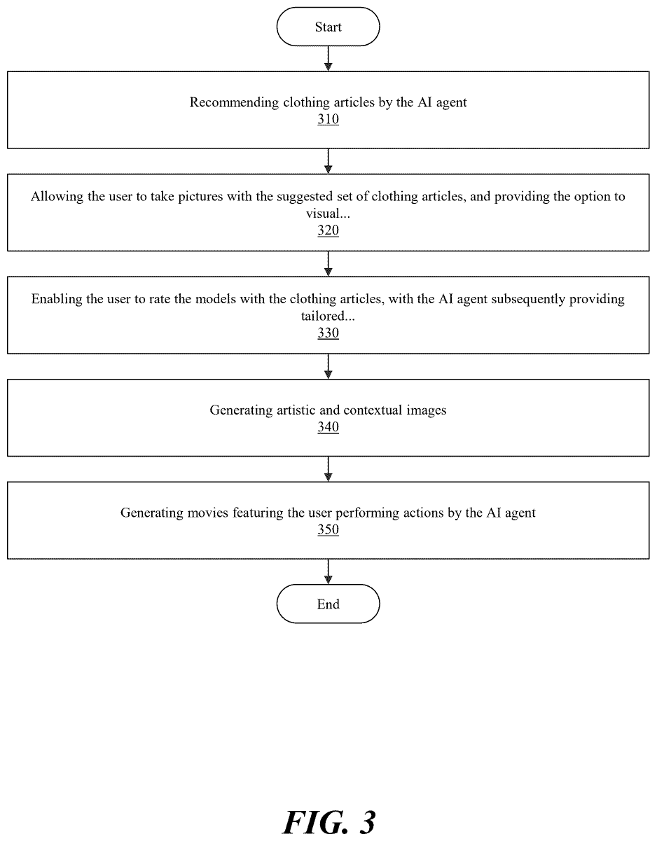

FIG. 3 is a flowchart that describes a method for utilizing a visual fitting room, according to some embodiments of the present disclosure. In some embodiments, at 310, the method may include recommending clothing articles by the AI agent. At 320, the method may include allowing the user to take pictures with the suggested set of clothing articles, and providing the option to visualize models or celebrities wearing the same clothing articles. At 330, the method may include enabling the user to rate the models with the clothing articles, with the AI agent subsequently providing tailored suggestions. At 340, the method may include generating artistic and contextual images. At 350, the method may include generating movies featuring the user performing actions by the AI agent.

In some embodiments, Detecting, by one or more processors, an encounter request from a user. An artificial intelligence engine may be coupled to the one or more processors. The artificial intelligence engine may be trained by human experts in the field. The AI agent may be configured to be displayed in LED/OLED displays, Android/iOS tablets, Laptops/PCs, or VR/AR goggles. The artificial intelligence engine may be configured to enable the AI agent to suggest a set of clothing articles based on the user's previous selections and clothing history.

In some embodiments, the user can then select the desired clothing articles to purchase based on the AI agent's recommendations. The AI agent may be configured to enable the user to take pictures with the clothing articles. The pictures can be real-time pictures of the user with the clothing articles and some accessories taken by AI agent. The pictures also can be pictures of the user uploaded by the user with a combination of real clothing articles, real accessories, visual clothing articles and accessories generated by the AI agent.

In some embodiments, the user also can change any part of the combination. The pictures also can be pictures of any models uploaded by the user with a combination of real clothing articles, real accessories, visual clothing articles and accessories generated by the AI agent. The real and visual clothing articles can be any of coats, shirts, pants, skirts and others. The real and visual accessories can be hats, watches, belts, sunglasses and others.

In some embodiments, the AI agent may be configured to create artistic representations or contextual images with work or other backgrounds. The AI agent may be configured to add makeup to the user in the generated images or videos, applicable to various types of clothing articles including wedding and work dresses. The user may be wearing and changing the clothing articles based on the user's choice. The AI agent may be configured to modify the dress, makeup, and accessories in the movie based on the user's input. In some embodiments, the artificial intelligence engine may be configured for real-time speech recognition, speech to text generation, real-time dialog generation, text to speech generation, voice-driven animation, and human avatar generation. In some embodiments, the AI companion agent may be configured to be displayed in full body or half body portrait mode or a face on top of a moving robot.

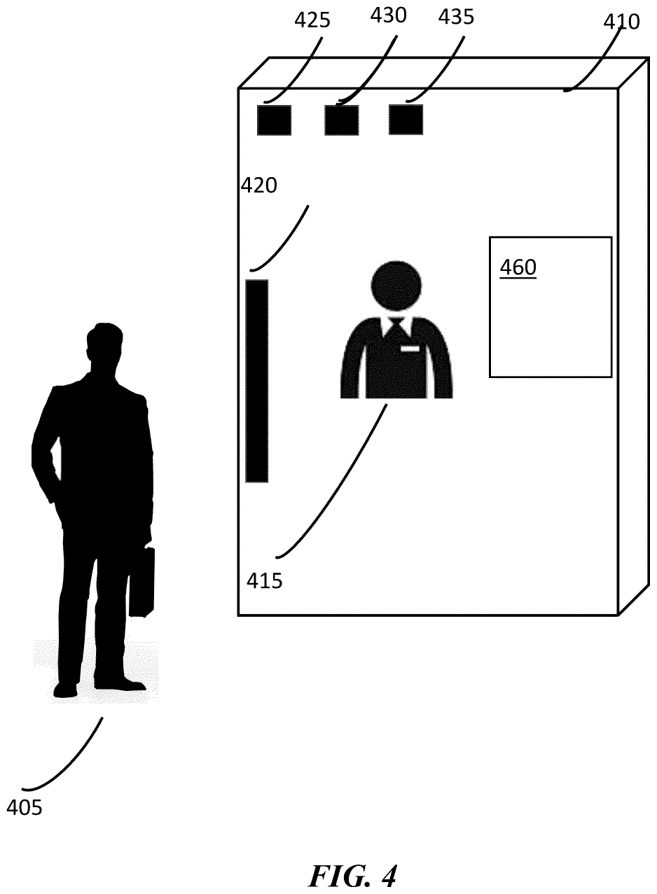

FIG. 4 is a diagram showing an example that describes a first example of a method for utilizing a visual fitting room, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to be used. In some embodiments, other users can use this service descripted in this paragraph.

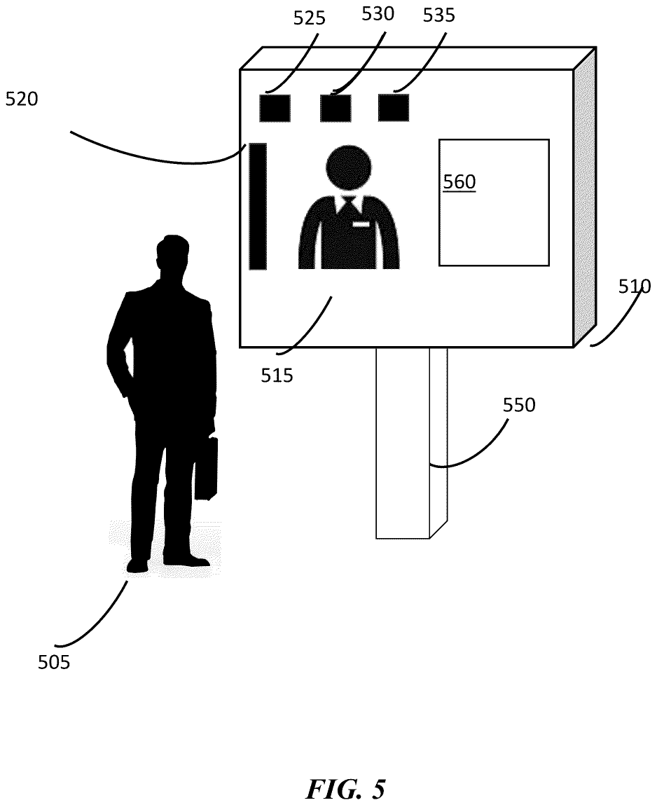

FIG. 5 is a diagram showing a second example of a method for utilizing a visual fitting room, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3., with the help of interactive panel 520. In some embodiments, user 505 can choose what language to be used. In some embodiments, other users can use this service descripted in this paragraph.

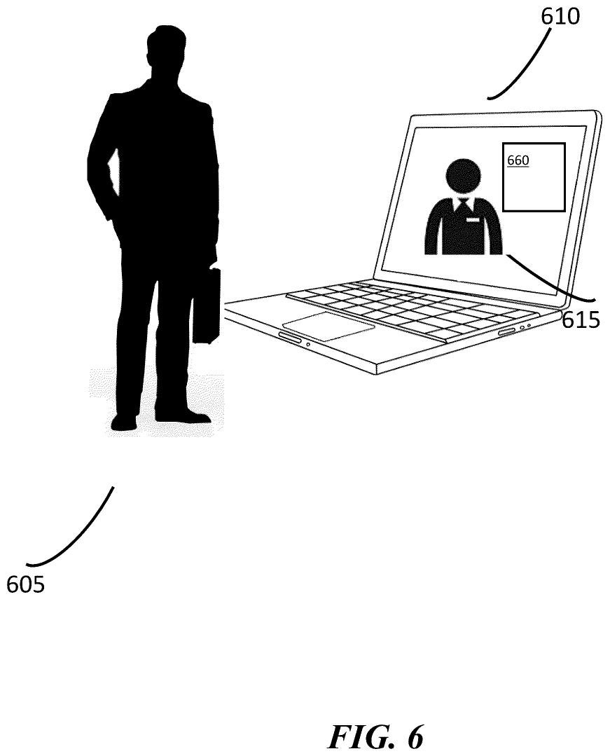

FIG. 6 is a diagram showing a third example of a method for utilizing a visual fitting room, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer, or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph.

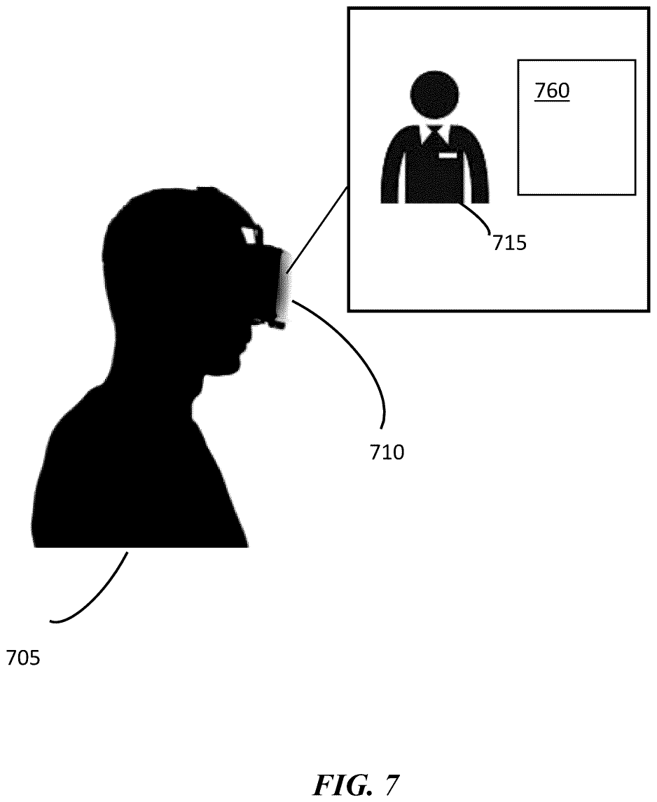

FIG. 7 is a diagram showing a fourth example of a method for utilizing a visual fitting room, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph.

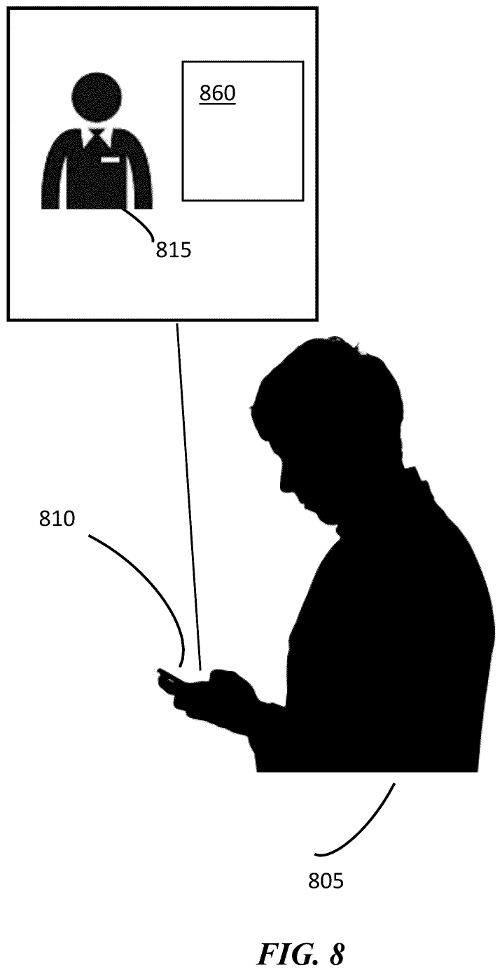

FIG. 8 is a diagram showing a fifth example of a method for utilizing a visual fitting room, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph.

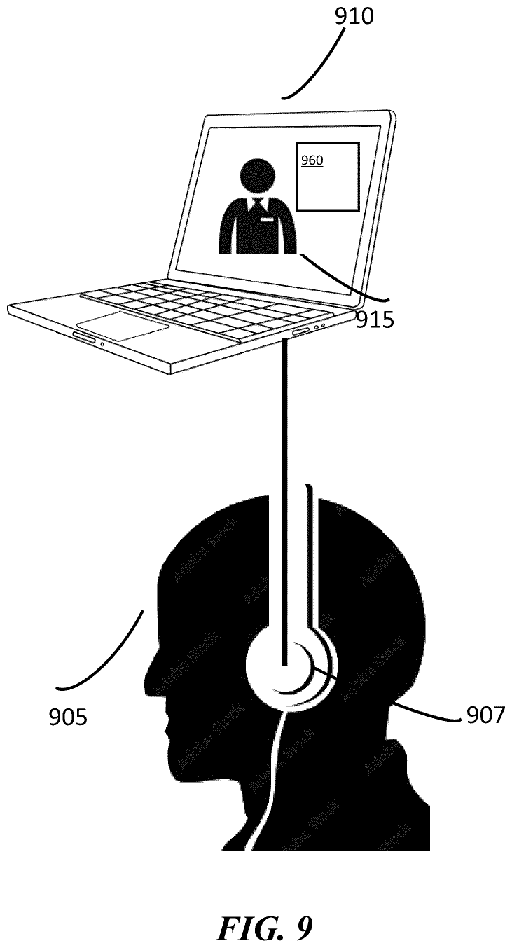

FIG. 9 is a diagram showing a sixth example of a method for utilizing a visual fitting room, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph.

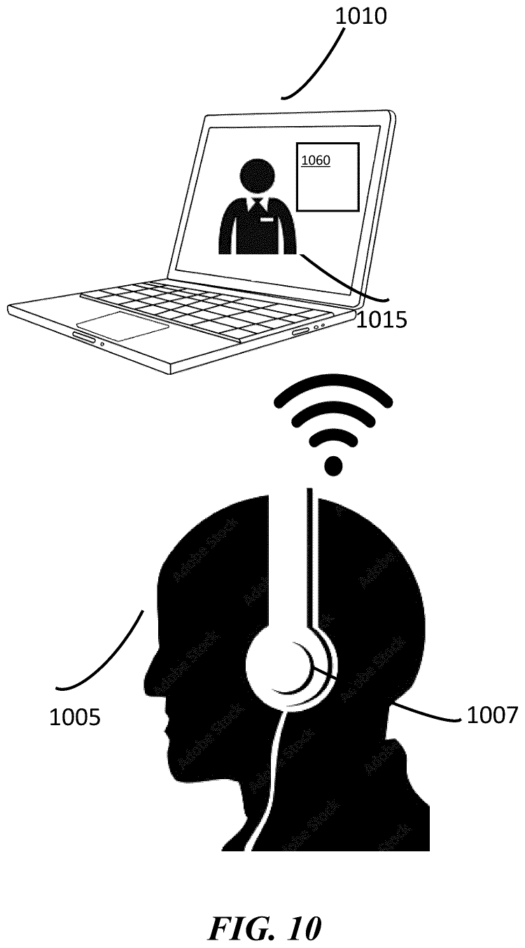

FIG. 10 is a diagram showing a seventh example of a method for utilizing a visual fitting room, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices relate to wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph.

1. A method for utilizing a visual fitting room through an artificial intelligence (AI) agent,
comprising:
Detecting, by one or more processors, an encounter request from a user, wherein an artificial intelligence engine is coupled to the one or more processors, wherein the artificial intelligence engine is trained by human experts in the field, wherein the AI agent is configured to be displayed in LED/OLED displays, Android/iOS tablets, Laptops/PCs, or VR/AR goggles, wherein a set of multi-layer info panels coupled to the one or more processors are configured to overlay graphics on top of the AI companion agent, wherein the AI agent is configured to be displayed with an appearance of a real human or a humanoid or a cartoon character or an animal character based on the user's choice, wherein the real human can be a movie star, wherein a set of pictures depicting the user's choice can be uploaded to the artificial intelligence engine, wherein the appearance of the AI agent could be determined by analysis of the set of pictures by the artificial intelligence engine, wherein the AI agent is configured to mimic different personalities, wherein the AI companion agent's gender, age and ethnicity is determined by the artificial Intelligence's analysis on input from the user;
Recommending clothing articles by the AI agent, wherein the artificial intelligence engine is configured to enable the AI agent to suggest a set of clothing articles based on the user's previous selections and clothing history;
Allowing the user to take pictures with the suggested set of clothing articles, and providing the option to visualize models or celebrities wearing the same clothing articles;
Enabling the user to rate the models with the clothing articles, with the AI agent subsequently providing tailored suggestions, wherein the user can then select the desired clothing articles to purchase based on the AI agent's recommendations;
Generating artistic and contextual images, wherein the AI agent is configured to enable the user to take pictures with the clothing articles, wherein the pictures can be real-time pictures of the user with the clothing articles and some accessories taken by AI agent, wherein the pictures also can be pictures of the user uploaded by the user with a combination of real clothing articles, real accessories, visual clothing articles and accessories generated by the AI agent, wherein the user also can change any part of the combination, wherein the pictures also can be pictures of any models uploaded by the user with a combination of real clothing articles, real accessories, visual clothing articles and accessories generated by the AI agent, wherein the real and visual clothing articles can be any of coats, shirts, pants, skirts and others, wherein the real and visual accessories can be hats, watches, belts, sunglasses and others, wherein the AI agent is configured to create artistic representations or contextual images with work or other backgrounds, wherein the AI agent is configured to add makeup to the user in the generated images or videos, applicable to various types of clothing articles including wedding and work dresses,
Generating movies featuring the user performing actions by the AI agent, wherein the user is wearing and changing the clothing articles based on the user's choice, wherein the AI agent is configured to modify the dress, makeup, and accessories in the movie based on the user's input.

2. The method for utilizing a visual fitting room through an artificial intelligence (AI) agent of claim 1, wherein the artificial intelligence engine is configured for real-time speech recognition, speech to text generation, real-time dialog generation, text to speech generation, voice-driven animation, and human avatar generation.

3. The method for utilizing a visual fitting room through an artificial intelligence (AI) agent of claim 1, wherein the AI companion agent is configured to be displayed in full body or half body portrait mode or a face on top of a moving robot.

4: A system for utilizing a visual fitting room through an artificial intelligence (AI) agent, comprising:
One or more processors configured to detect an encounter request from a user;
An artificial intelligence engine coupled to the one or more processors, trained by human experts in the field and configured to:
Display the AI agent in various devices such as LED/OLED displays, Android/iOS tablets, Laptops/PCs, or VR/AR goggles;
Overlay graphics on the AI companion agent using a set of multi-layer info panels;
Display the AI agent with an appearance of a real human, humanoid, cartoon character, or animal character based on the user's choice, with the capability to depict movie stars;
Analyze a set of pictures uploaded by the user to determine the appearance of the AI agent;
Mimic different personalities, and determine the AI companion agent's gender, age, and ethnicity based on user input;
A recommendation module configured to enable the AI agent to suggest a set of clothing articles based on the user's previous selections and clothing history;
An interaction module configured to allow the user to take pictures with the suggested set of clothing articles, and visualize models or celebrities wearing the same clothing articles;
A scoring and suggestion module configured to:
Enable the user to rate the models with the clothing articles;
Provide tailored suggestions based on the user's ratings;
Allow the user to select the desired clothing articles to purchase based on the AI agent's recommendations;
An image generation module configured to:
Enable the user to take pictures with the clothing articles, wherein the pictures can be real-time pictures of the user with the clothing articles and some accessories taken by AI agent, wherein the pictures also can be pictures of the user uploaded by the user with a combination of real clothing articles, real accessories, visual clothing articles and accessories generated by the AI agent, wherein the user also can change any part of the combination, wherein the pictures also can be pictures of any models uploaded by the user with a combination of real clothing articles, real accessories, visual clothing articles and accessories generated by the AI agent, wherein the real and visual clothing articles can be any of coats, shirts, pants, skirts and others, wherein the real and visual accessories can be hats, watches, belts, sunglasses and others;
Create artistic representations or contextual images with work or other backgrounds;
Add makeup to the user in the generated images or videos, applicable to various types of clothing articles including wedding and work dresses;
A motion picture generation module configured to:
Generate movies featuring the user performing actions while wearing and changing the clothing articles based on the user's choice;
Modify the dress, makeup, and accessories in the movie based on the user's input.

5. The method for utilizing a visual fitting room through an artificial intelligence (AI) agent of claim 4, wherein the artificial intelligence engine is configured for real-time speech recognition, speech to text generation, real-time dialog generation, text to speech generation, voice-driven animation, and human avatar generation.

6. The method for utilizing a visual fitting room through an artificial intelligence (AI) agent of claim 4, wherein the AI companion agent is configured to be displayed in full body or half body portrait mode or a face on top of a moving robot.

7. A method for utilizing a visual fitting room through an artificial intelligence (AI) agent, comprising:
Detecting, by one or more processors, an encounter request from a user, wherein an artificial intelligence engine is coupled to the one or more processors, wherein the artificial intelligence engine is trained by human experts in the field, wherein the AI agent is configured to be displayed in LED/OLED displays, Android/iOS tablets, Laptops/PCs, or VR/AR goggles;
Recommending clothing articles by the AI agent, wherein the artificial intelligence engine is configured to enable the AI agent to suggest a set of clothing articles based on the user's previous selections and clothing history;
Allowing the user to take pictures with the suggested set of clothing articles, and providing the option to visualize models or celebrities wearing the same clothing articles;
Enabling the user to rate the models with the clothing articles, with the AI agent subsequently providing tailored suggestions, wherein the user can then select the desired clothing articles to purchase based on the AI agent's recommendations;
Generating artistic and contextual images, wherein the AI agent is configured to enable the user to take pictures with the clothing articles, wherein the pictures can be real-time pictures of the user with the clothing articles and some accessories taken by AI agent, wherein the pictures also can be pictures of the user uploaded by the user with a combination of real clothing articles, real accessories, visual clothing articles and accessories generated by the AI agent, wherein the user also can change any part of the combination, wherein the pictures also can be pictures of any models uploaded by the user with a combination of real clothing articles, real accessories, visual clothing articles and accessories generated by the AI agent, wherein the real and visual clothing articles can be any of coats, shirts, pants, skirts and others, wherein the real and visual accessories can be hats, watches, belts, sunglasses and others, wherein the AI agent is configured to create artistic representations or contextual images with work or other backgrounds, wherein the AI agent is configured to add makeup to the user in the generated images or videos, applicable to various types of clothing articles including wedding and work dresses;
Generating movies featuring the user performing actions by the AI agent, wherein the user is wearing and changing the clothing articles based on the user's choice, wherein the AI agent is configured to modify the dress, makeup, and accessories in the movie based on the user's input.

8. The method for utilizing a visual fitting room through an artificial intelligence (AI) agent of claim 7, wherein the artificial intelligence engine is configured for real-time speech recognition, speech to text generation, real-time dialog generation, text to speech generation, voice-driven animation, and human avatar generation.

9. The method for utilizing a visual fitting room through an artificial intelligence (AI) agent of claim 7, wherein the AI companion agent is configured to be displayed in full body or half body portrait mode or a face on top of a moving robot.
